(19) United States
(12) Patent Application Publication
(10) Pub. No.: US 2024/0334261 A1
(43) Pub. Date: Oct. 3, 2024

(54) NEW RADIO (NR) INTEGRATED ACCESS AND BACKHAUL (IAB) – MEASUREMENT RELATED ENHANCEMENTS FOR MOBILE CELLS

(71) Applicant: INTERDIGITAL PATENT HOLDINGS, INC., Wilmington, DE (US)

(72) Inventors: Oumer Teyeb, Montreal (CA); Martino Freda, Laval (CA)

(73) Assignee: INTERDIGITAL PATENT HOLDINGS, INC., Wilmington, DE (US)

(21) Appl. No.: 18/293,396

(22) PCT Filed: Aug. 3, 2022
(86) PCT No.: PCT/US2022/039310

§ 371 Date: Jan. 30, 2024

Related U.S. Application Data
(60) Provisional application No. 63/228,902, filed on Aug. 3, 2021.

(51) Int. Cl. H04W 36/00

(52) U.S. Cl. CPC H04W 36/0058; H04W 36/0061

(57) ABSTRACT

A method performed by a wireless transmit/receive unit (WTRU) may compromise receiving configuration information including neighbor cell and serving cell measurement behavior information, wherein the configuration information is dependent on a mobility state of the neighbor cell and the serving cell and conducting measurements in accordance with the neighbor cell and serving cell measurement behavior information, wherein conducting measurements in accordance with the neighbor cell and serving cell measurement behavior that corresponds with the mobility state of the neighbor cell and serving cell includes at least one of the following: starting or stopping performing neighbor cell measurements or serving cell measurements; starting or stopping sending neighbor cell measurement reports or serving neighbor cell measurement reports; performing the measurements in a relaxed manner; or applying different parameters for measurement evaluation.

### CROSS-REFERENCE TO RELATED APPLICATIONS

This application claims the benefit of U.S. Provisional Application No. 63/228,902, filed Aug. 3, 2021, the contents of which are incorporated herein by reference.

### BACKGROUND

Integrated access and backhaul (IAB), where part of the wireless spectrum is used for the backhaul connection of base stations instead of fiber, allows for a more flexible and cheaper deployment of dense networks as compared to deployments where there is a dedicated fiber link to the base stations. A full-fledged, multi-hop, IAB solution that is based on split architecture (i.e., Centralized Unit (CU) and Distributed Unit (DU) architecture) has been specified for New Radio (NR).

### SUMMARY

A method performed by a wireless transmit/receive unit (WTRU) may compromise receiving configuration information including neighbor cell and serving cell measurement behavior information, wherein the configuration information is dependent on a mobility state of the neighbor cell and the serving cell and conducting measurements in accordance with the neighbor cell and serving cell measurement behavior information, wherein conducting measurements in accordance with the neighbor cell and serving cell measurement behavior that corresponds with the mobility state of the neighbor cell and serving cell includes at least one of the following: starting or stopping performing neighbor cell measurements or serving cell measurements; starting or stopping sending neighbor cell measurement reports or serving neighbor cell measurement reports; performing the measurements in a relaxed manner; or applying different parameters for measurement evaluation.

Performing the measurements in a relaxed manner may include at the least one of the following: applying longer measurements periods and reducing a number of measurement samples taken. Applying different parameters for measurement values may include applying at least one of the following: different time-to-trigger (TTT) values and different hysteresis values.

The starting of performing neighbor cell measurements may occur after the mobility state of the serving cell changes from moving to static. The stopping of performing neighbor cell measurements may occur after the mobility state of the serving cell changes from static to moving. The starting of performing neighbor cell measurements may occur after the mobility state of the neighbor cell changes from moving to static. The stopping of performing neighbor cell measurements may occur after the mobility state of the neighbor cell changes from static to moving. The starting or stopping of performing neighbor cell measurements may be based on a location of the WTRU. Performing measurements in the relaxed manner may occur in a gradual manner.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram of an integrated access and backhaul (IAB) user plane, according to an embodiment;

FIG. 3 is a diagram of an IAB control plane, according to an embodiment;

FIGS. 4A and 4B are diagrams of inter-cu IAB topology adaptations, according to an embodiment;

FIG. 5 is a diagram illustrating an example procedure performed between a serving cell, neighbor cell, and WTRU, according to an embodiment.

### DETAILED DESCRIPTION

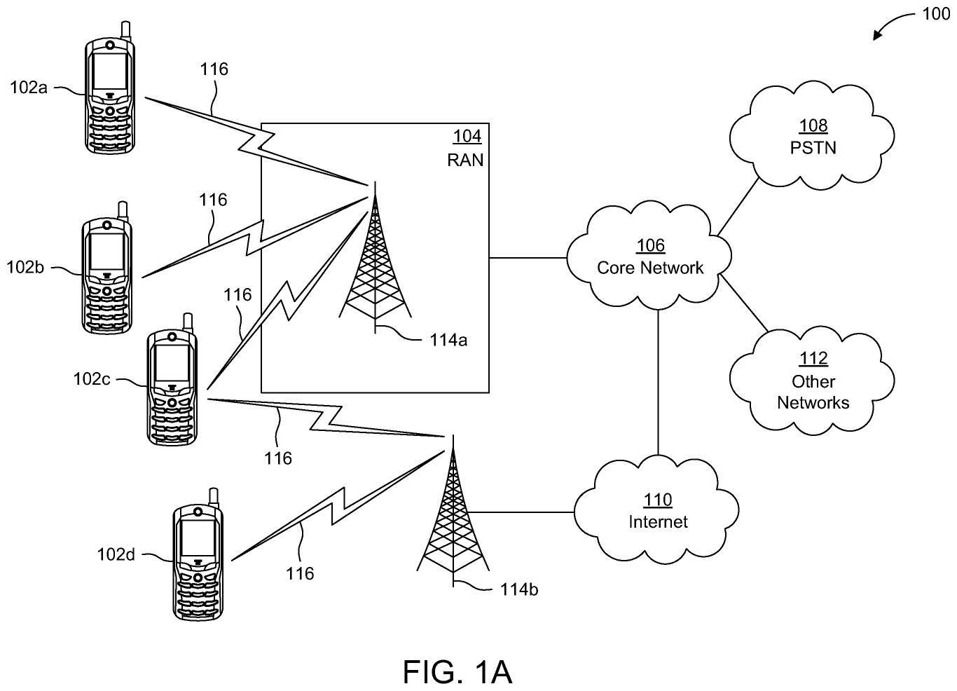

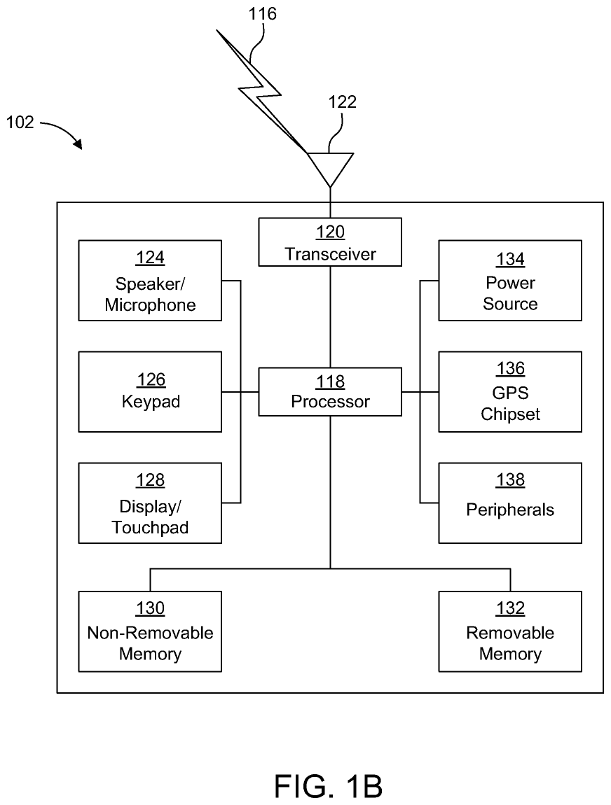

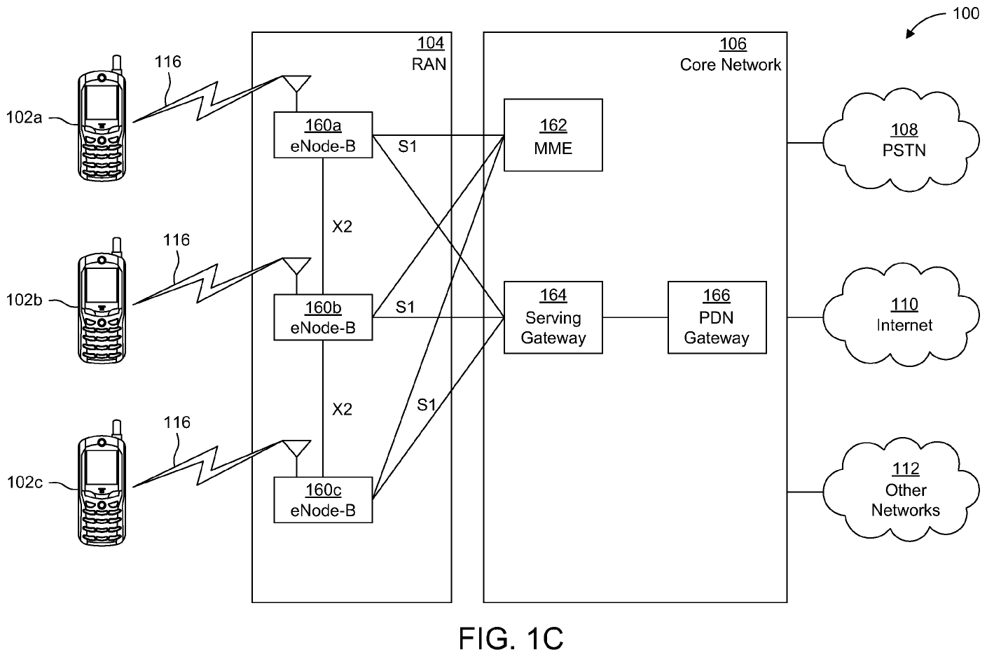

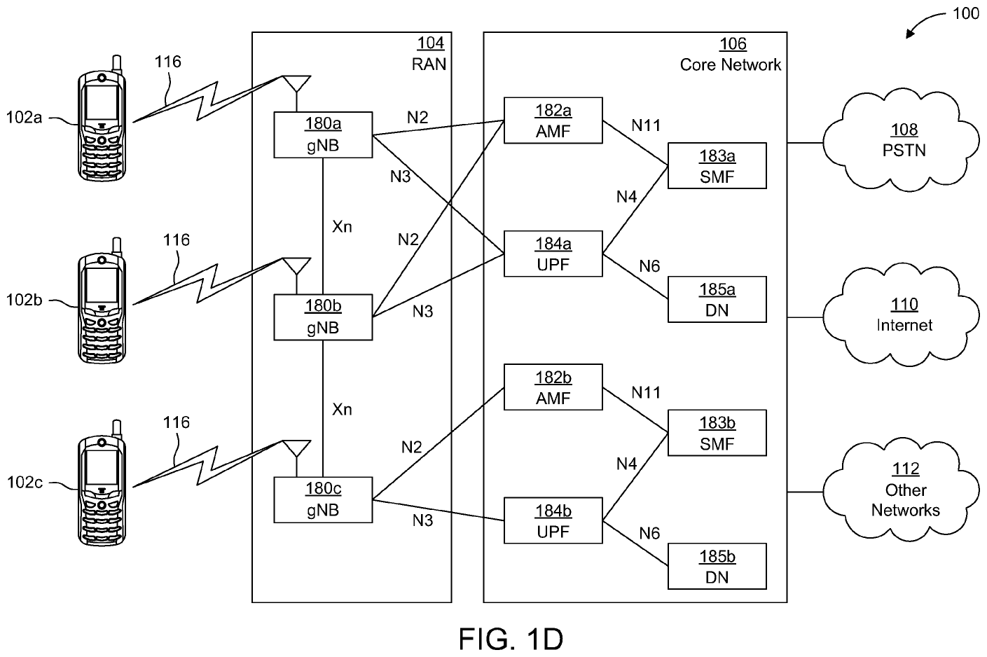

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As discussed above, integrated access and backhaul (IAB), where part of the wireless spectrum is used for the backhaul connection of base stations instead of fiber, allows a more flexible and cheaper deployment of dense networks as compared to deployments where there is a dedicated fiber link to the base stations. A full-fledged, multi-hop, IAB solution that is based on split architecture (i.e. Centralized Unit (CU) and Distributed Unit (DU) architecture) has been specified for New Radio (NR).

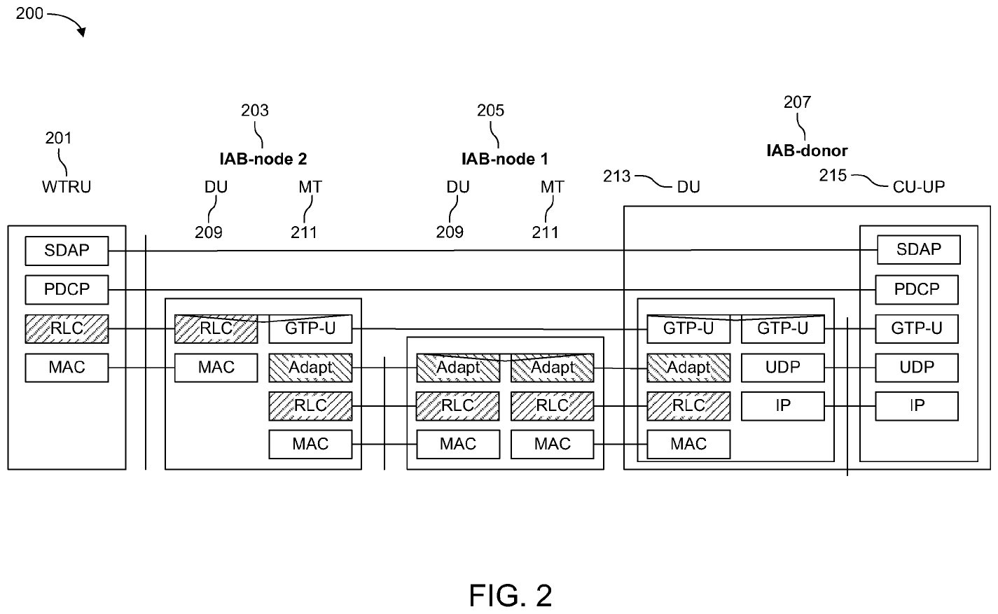

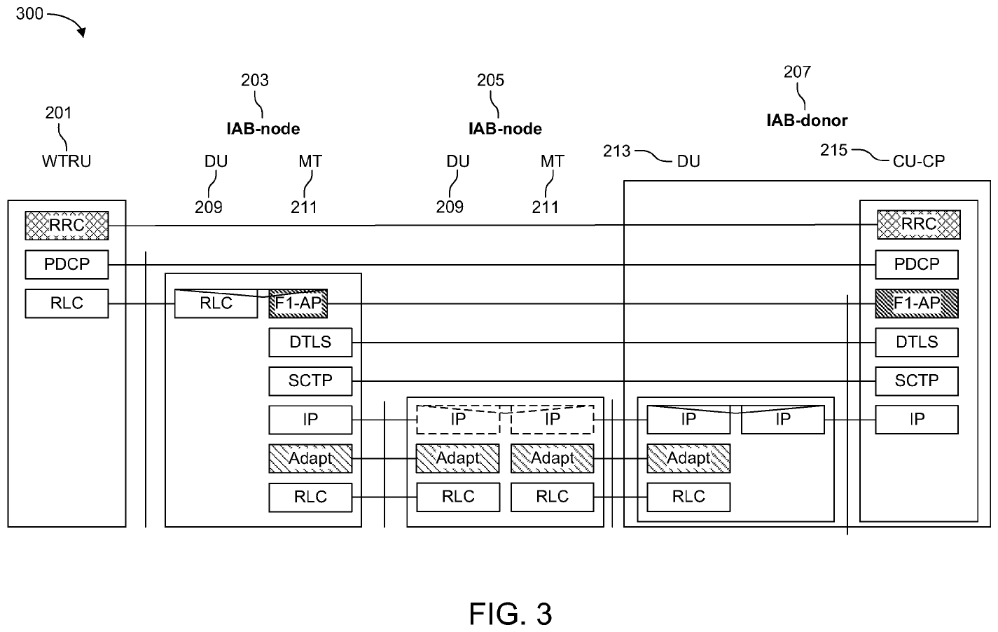

FIG. 2 illustrates an IAB user plane (UP) protocol architecture 200, according to an embodiment. FIG. 3 illustrates an IAB control plane (CP) protocol architecture 300, according to an embodiment. The UP architecture 200 and the CP architecture 300 may comprise a mobile termination (MT) part 211, which may be used to communicate with a parent node, and a DU part 209, which may be used to communicate with a child node or a normal WTRU (e.g., WTRU 201). Both the UP and CP architectures may employ a routing/forwarding approach inspired by IP networks, where each IAB node is assigned an IP address that is routable from a donor base station (and associated L2 addresses), and intermediate IAB nodes forward the packets transparently based on route identifiers/destination addresses. The IAB node may terminate the DU functionality. A base station, which may be referred to as an IAB-donor 207, may terminate the CU functionality 215. Thus, the IAB node and donor CU 215 may form one logical base station unit employing CU/DU split architecture regardless of how many hops apart the IAB node and donor CU are physically from each other. The IAB node serving a WTRU (e.g., IAB node 203 serving WTRU 201 in FIG. 2), may be referred to as the access IAB node while the nodes between the IAB donor DU and the access IAB node (e.g., IAB node 205 in FIG. 2) may be referred to as intermediate IAB nodes. In some embodiments, an IAB node may play the role of both an access IAB node (for the WTRUs that are directly connected to it) and an intermediate IAB node (for WTRUs that are served by its descendant IAB nodes).

Hop-by-hop (H2H) RLC may be used between the IAB nodes, instead of an end-to-end (E2E) RLC between the donor DU 213 and the WTRU 201. An adaption layer, referred to as backhaul adaptation protocol (BAP), may be used to enable efficient multi-hop forwarding. The IAB-donor 207 may assign a unique L2 address (BAP address) to each IAB node that it controls (e.g., IAB node 203 and IAB node 205). In case of multiple paths, multiple route IDs may be associated to each BAP address. The BAP of the origin node (IAB-donor DU for the DL traffic, and the access IAB node for the UL) may add a BAP header to packets they are transmitting, which may include a BAP routing ID (e.g., BAP address of the destination/source IAB node and the path ID). If a packet arrives that has a BAP routing ID that contains a BAP address that is equal to the IAB nodes BAP address, it knows the packet is destined for it and passes it on to higher layers for processing (i.e., an F1-C/U message destined for the IAB node's DU, an F1-C message that contains SRB data for a WTRU directly connected to the IAB node, or an F1-U message that contains DRB data for a WTRU directly connected to the IAB node). Otherwise, the IAB node may employ routing/mapping tables to determine where to forward the data to. Each IAB node may have a routing table (configured by the IAB donor CU) containing the next hop identifier for each BAP routing ID. Separate routing tables are kept for the DL and UL direction, where the DL table is used by the DU part of the IAB node, while the MT part of the IAB node uses the UL table.

Backhaul (BH) RLC channels are used for transporting packets between IAB nodes (or between an IAB-donor DU and an IAB node). A BH RLC channel configuration contains the associated RLC and logical channel configuration. Either many-to-one (N:1) or one-to-one (1:1) mapping may be performed between WTRU radio bearers and BH RLC channels. N:1 mapping multiplexes several WTRU radio bearers into a single BH RLC channel based on specific parameters, such as QoS profile of the bearers, and is suitable for bearers that do not have very strict requirements such as best effort bearers. The 1:1 mapping, on the other hand, maps each WTRU radio bearer onto a separate BH RLC channel, and is designed to ensure finer QoS granularity at WTRU radio bearer level. 1:1 mapping is suitable for bearers with strict throughput or/and latency requirements, such as Guaranteed Bit Rate (GBR) bearers or VoIP bearers.

When an IAB node detects a BH radio link failure (RLF), the IAB node may send a BH RLF indication, which is a BAP control PDU, to its descendant nodes. Upon receiving such an indication form a parent node, the IAB node may initiate certain procedures, including re-establishment to another parent or pause transmission/reception with the concerned parent.

In a multi-hop IAB network, data congestion may occur on intermediate IAB nodes. If left unresolved, this congestion may lead to dropped packets. Though higher layer protocols such as TCP may be used to assure reliability, TCP congestion avoidance and slow start mechanisms may be very costly to overall end-to-end performance (e.g. throughput degradation). Therefore, IAB networks employ flow control. For the DL, both E2E and H2H flow control mechanisms are available.

The DL E2E flow control is based on the DL Data Delivery Status (DDDS) specified for CU/DU split architecture. In DDDS, the DU (in the context of IAB networks, the DU part of the access IAB node) reports to the CU (in the context of IAB networks, the donor CU, specifically, the CU-UP) information such as the desired buffer size per DRB, desired data rate per DRB, the highest successfully delivered PDCP SN, lost packets (i.e. not acknowledged by the DU at RLC level), etc. In some embodiments, only access IAB nodes perform DDDS (i.e. IABs report only information concerning the DRBs of the WTRUs that they are directly serving) and no information is provided regarding the BH RLC channels.

For DL H2H flow control, an IAB node generates a flow control message (which is also a BAP control PDU) when its buffer load exceed a certain level or when it receives a flow control polling message from a peer BAP entity (e.g. a child node). In some embodiments, the H2H flow control information indicates the available buffer size and may be at the granularity of BH RLC channels (e.g., available buffer=value_1 for BH RLC channel #1, available buffer=value_2 or per BH RLC channel #2, etc.) or destination routing ID (e.g. available buffer=value_1 for destination routing ID=address1, available buffer=value2 for destination routing ID=addres2, etc.). The node receiving the flow control message may use the information to control the traffic flow towards the sender (e.g., throttle or pause the traffic associated with certain BH RLC channel or/and destination if the flow control message indicated a low available buffer for the concerned traffic, increase the traffic flow if the flow control was indicating a high available buffer value, etc.). The exact actions taken on flow control and the configurations/values of thresholds and other parameters to trigger flow control message (e.g., buffer threshold values, polling timers, etc.) are not specified and left to IAB/network implementation.

Pre-emptive buffer status reporting (BSR) has been specified, where an IAB node may trigger BSR to its parent node(s) even before new data has arrived in its UL buffer, based on the BSR that it has received from its child nodes or WTRUs, or scheduling grants it has provided to them (i.e. an indication of anticipated data). Legacy NR mechanisms are applied where an IAB node controls the flow of UL data from its children nodes and WTRUs by the providing them with proper UL scheduling grants based on the BSR received from them. In some embodiments, IAB nodes are static nodes. However, handover of IAB nodes (also referred to as migration or relocation) from one donor to another is supported for load balancing and also for handling radio link failures (RLFs) due to blockage, e.g., due to moving objects, such as vehicles, seasonal changes (foliage), or infrastructure changes (new buildings). Intra-donor CU handover is supported (i.e. the target and the source parent DUs of the IAB node are controlled by the same donor CU) and inter-donor CU handover is expected to be specified.

IAB connectivity via MR-DC is supported. For example, an IAB node may be connected to the network via EN-DC, where the master node is an LTE node and the secondary node is an NR node.

In some embodiments, from a WTRU's point of view, IAB nodes appear to be normal base stations).

The migrations/relocations of an IAB node from one parent node to another (possibly involving a change of the donor DU or even donor CU) is specified for load balancing or backhaul RLF handling. Such a migration of an IAB node may also be referred to as topology adaptation.

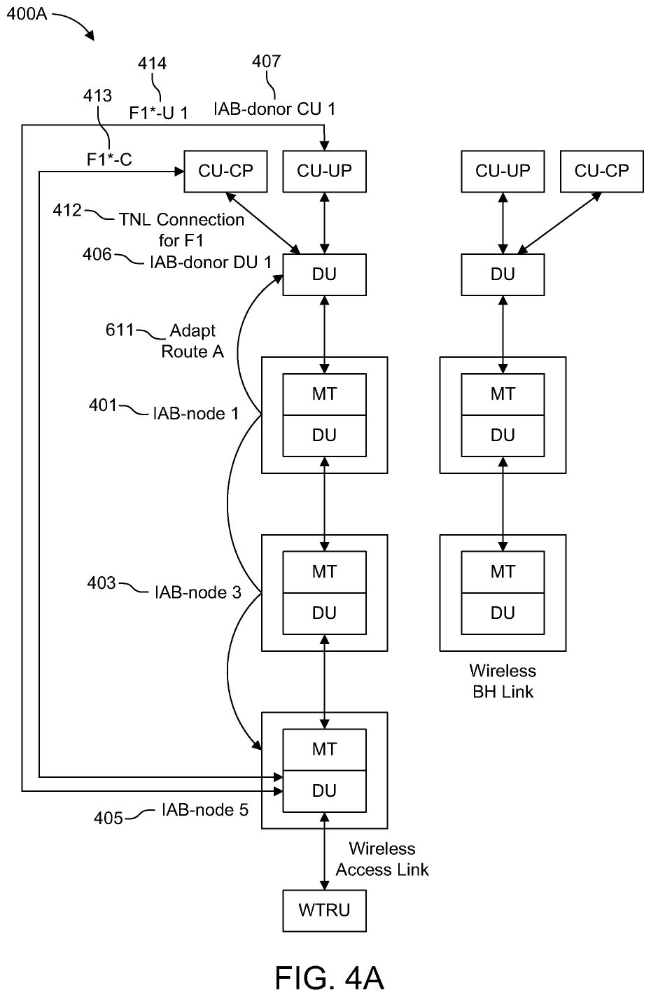

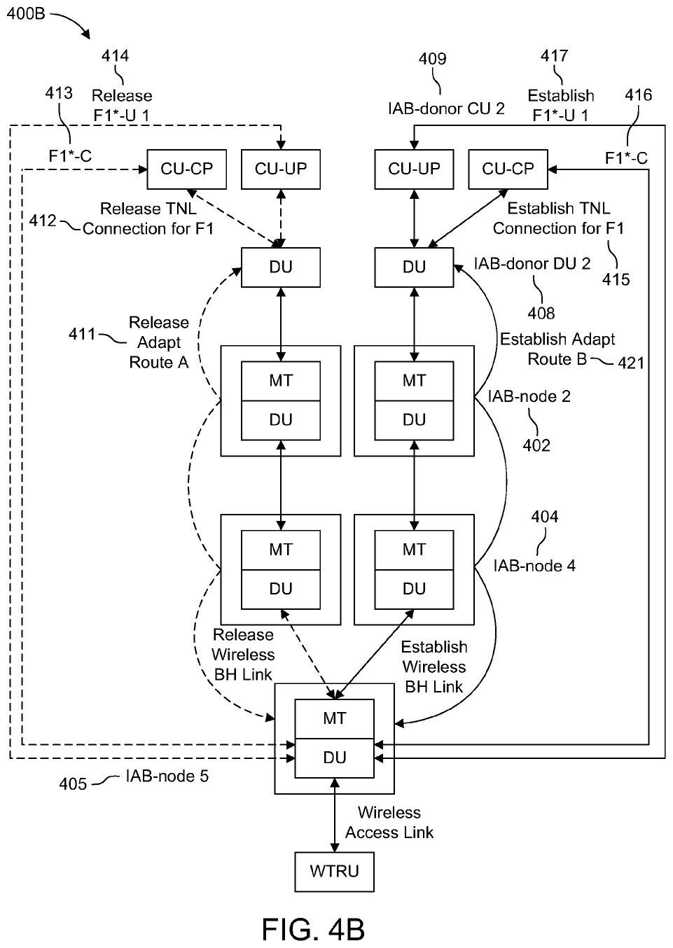

FIGS. 4A and 4B illustrate inter-CU topology adaptation 400A, 400B, according to an embodiment. In some embodiments, a topology adaptation may comprise establishment of new route/resources via the new parent CU/path. For example, in the embodiment illustrated in FIG. 4A, adapt route A 411 is established between IAB-node 405, IAN-node 403, IAB-node 401, and IAB-donor DU 406. During the topology adaptation new adapt route B 421 may be established between IAB-node 405, IAB-node 404, IAB-node 402, and IAB-donor DU 408, as illustrated in FIG. 4B.

In some embodiments, a topology adaptation may further comprise redirection of F1-U tunnels and F1-AP onto new route. For example, in the embodiment illustrated in FIG. 4A, tunnel connection for F1 412 is established between IAB-donor DU 406 and IAB-donor CU 407; F1-C 413 is established between the DU of IAB-node 405 and the CU-CP of IAB-donor CU 407; and F1-U1 614 is established between the DU of IAB-node 405 and the CU-UP of IAB-donor CU 407, as illustrated in FIG. 4A. Tunnel connection for F1 412 may be redirected to tunnel connection for F1 415 between IAB-donor DU 408 and IAB-donor 409. Similarly, F1-C 413 and F1-U1 414 may be redirected to F1-C 416 and F1-C 417, as illustrated in FIG. 4B.

In some embodiments, a topology adaptation may further comprise the release of old route/resources. For example, the following routes/resources are released in the embodiment illustrated in FIG. 4B: adapt route A 411, tunnel connection for F1 412, F1-C 413, and F1-U1 414.

In RRC_CONNECTED mode, a WTRU may measure one or more beams of a cell and the measurements results (i.e., power values) may be averaged to derive the cell quality. The WTRU may be configured to consider a subset of the detected beams. Filtering may take place at two different levels: (1) at the physical layer to derive beam quality and (2) at the RRC level to derive cell quality from multiple beams. Cell quality from beam measurements may be derived in the same way for the serving cell(s) and for the non-serving cell(s). Measurement reports may contain the measurement results of the X-best beams if the WTRU is configured to do so by the gNB.

The measurement reporting configuration may be either event triggered or periodical. If the measurement reporting is periodical, the WTRU may send the measurement report every reporting interval. For example, the range may be between 120 ms and 30 min.

For event triggered measurements, the WTRU may send the measurement report when the conditions associated with the event are fulfilled. The WTRU may continue to measure serving cell and neighbor cell report quantity and validate it with the threshold or offset defined in a report configuration. The report quantity that is used to trigger for event may be RSRP, RSRQ or SINR.

The following Intra-RAT measurement events may be defined for NR: (1) Event A1; (2) Event A2; (3) Event A3; (4) Event A4; (5) Event A5; and (6) Event A6.

In Event A1, the serving cell becomes better than the threshold. Event A1 may be used to cancel an ongoing handover procedure. This may be required if a WTRU moves towards cell edge and triggers a mobility procedure, but then subsequently moves back into good coverage before the mobility procedure has completed.

In Event A2, the serving cell becomes worse than the threshold. Because Event A2 does not involve any neighbor cell measurements, Event A2 is typically used to trigger a blind mobility procedure, or the network may configure the WTRU for neighbor cell measurements when it receives a measurement report that is triggered due to Event A2 in order to save WTRU battery (i.e. not perform neighbor cell measurement when the serving cell quality is good enough).

In Event A3, the neighbor cell becomes offset better than the special cell (SpCell). Event A3 may be used for a handover procedure. Note that the SpCell is the primary serving cell of either the Master Cell Group (MCG)(i.e. the PCell), or the Secondary Cell Group (SCG) (i.e. the PSCell). Thus, in DC operation, the Secondary Node (SN) may configure an A3 event for SN triggered PSCell change.

In Event A4, the neighbor cell becomes better than threshold. Event A4, may be used for handover procedures that do not depend upon the coverage of the serving cell (e.g., load balancing, where the WTRU is handed over to a good neighbor cell even if the serving cell conditions are excellent).

In Event A5, the SpCell becomes worse than threshold-1 and neighbor becomes better than the threshold-2. Like Event A3, Event A5 is typically used for handover, but unlike Event A3, it provides a handover triggering mechanism based upon absolute measurements of the serving and neighbor cell, while Event A3 uses relative comparison. As such, it is suitable for time critical handover when the serving cell becomes weak and it is necessary to change towards another cell which may not satisfy the criteria for an Event A3 handover.

In Event A6, the neighbor cell becomes offset better than the SCell. Event A1 is used for SCell addition/releasing.

Event B1 and Event B2 are defined for Inter-RAT measurement in NR. In Event B1, the Inter RAT neighbor cell becomes better than a threshold. Event B1 is equivalent to Event A4, but for the case of the inter-RAT handover. In Event B2, the PCell becomes worse than threshold-1 and inter RAT neighbor becomes better than threshold-2. Event B1 is equivalent to A5, except for the case of inter-RAT handover.

The WTRU's measurement configuration may contain a s-measure configuration (s-MeasureConfig), which specifies a threshold for NR SpCell RSRP measurement controlling when the WTRU is required to perform measurements on non-serving cells. The value may be a threshold corresponding to the PCell's or PSCell's RSRP. If the measured PCell RSRP is above the s-measure threshold, the WTRU will not perform measurements on non-serving cells, improving WTRU power consumption (i.e., the WTRU does not perform unnecessary measurements if it has very good radio conditions towards the serving cells).

Though the rel-17 work on IAB enhancements is specifying signaling enhancements to optimize the migration of an IAB node from one donor to another, it is all done under the assumption that the migration of the IAB node is being performed for load balancing or to handle unexpected RLF, and not mobility. Problems arise if an IAB node supports full mobility (e.g., deployed on fast moving vehicle).

One problem is ping-pong handovers of bystander WTRUs outside the vehicle. For example, WTRUs near a bus/train stop connect to a mobile IAB node on the bus/train and immediately become disconnected.

A second problem is ping-pong handovers of WTRUs inside a vehicle. For example, WTRUs connecting to a cell outside the mobile IAB node temporarily, when the train passes another train or temporarily stops at a station.

A third problem is that an IAB node, mobile or stationary, may temporarily connect to a moving IAB node, just to handover to another parent node immediately after.

Many of the embodiments described below are described for a WTRU or IAB node. However, the embodiments are equally applicable to other kind of nodes or devices, such as a traditional WTRU, or a sidelink WTRU acting as a WTRU-to-WTRU relay or WTRU to NW relay (e.g., over sidelink). Unless otherwise specified, the embodiments that are described for a WTRU may also apply to an IAB node that is being served by another IAB node.

A direct descendant or a child node of a certain IAB node may be an IAB node/WTRU that is directly connected to the IAB node (e.g. a mobile terminal or node being served by the IAB node). In a multi-hop case, a given IAB node may be serving a node/WTRU indirectly if the node/WTRU is not directly connected to the IAB node but UL/DL traffic of the node/WTRU has to traverse through the given IAB node before arriving at the node/WTRU (in the UL direction) or the donor node (in the DL direction). The generic term “descendant” may be used to refer to all the nodes/WTRUs that are directly or indirectly served by the IAB node.

In the descriptions below, the term “mobile cell” may be used to describe a cell that belongs to a mobile IAB node (i.e., an IAB node that contains an MT and a DU part) or any network node (e.g., a full gNB, the DU part of a gNB in operating under CU-DU split architecture, a relay node, etc.), that is capable of mobility. Under some conditions, the embodiments may even apply to a network node that is not mobile, if a similar behavior is desired. One such condition may be a scenario where a WTRU is stationary for a long duration.

An IAB node may be configured to indicate whether it supports mobility or not. The IAB node may indicate whether is supports mobility or not to WTRUs and other IAB nodes it is serving in one or more of the following methods as described below.

The IAB node may indicate whether it supports mobility or not by using a new information element (IE) on the system information broadcast of the IAB node's DU. For example, a “0” may represent a static IAB node and a “1” may indicate mobile IAB nodes (or vice versa). In another example, absence of the flag in the SI may indicate a static IAB node and the presence of the flag may indicate a mobile IAB node (or vice versa).

The IAB node may indicate whether it supports mobility or not from one IAB node to another IAB node. For example, an IAB node may send a WTRU Information Request to another IAB node that it is currently serving to request its mobility support. In another example, an IAB node may send a WTRU Assistance Information message to a parent IAB node that includes the IAB node's mobility support.

The node may indicate whether it supports mobility or not by broadcasting a new SIB specific related to system information for mobile IAB nodes. For example, a static IAB node may not broadcast/support a specific SIB (e.g., SIBx) while a mobile IAB node may broadcast/support such SIB.

WTRUs or IAB nodes may be configured with respect to the mobility support of IAB nodes. In one embodiment, the WTRUs or IAB may provide an implicit indication. For example, the WTRUs or IAB nodes may configured with a Physical Cell ID (PCI) or Cell Global Identity (CGI) that fall within a given range (e.g., PCIs x to y correspond to mobile cells or PCIs a to d belong to static cells, etc.). In another example, the WTRUs or IAB nodes may be configured with a given range of operating frequencies (e.g., mobile cells are configured to operate on frequency range x to y).

In an embodiment, there may be an on-demand request from a WTRU or IAB node. For example, the WTRU or an IAB node may send a request (e.g., mobility support capability request) to the IAB node, and the IAB node may send a response the WTRU on whether it supports mobility or not.

The mobility support indication may be more granular than a “Yes/No” indication. For example, a “0” may indicate a static IAB node, a “1” may indicate an IAB node that may move at slow speeds, a “2” may indicate a node that may move at medium speed, and a “3” may indicate a node capable of high speed. Further values may provide additional indications.

An IAB node may also be configured to indicate its current mobility state (i.e., currently static or moving). Any of the mechanisms described above to indicate mobility support may also be used to indicate the IAB node's current mobility state.

In an embodiment, the current mobility state indication may be more granular that just an indication whether the IAB node is currently static or moving. For example, one or more of the following additional pieces of information may be included: (1) a more granular flag where “0” indicates static IAB node, “1” indicates a slow-moving node, “2” indicates a node moving at medium level, “3” indicates high speed IAB node, etc.; (2) direction of movement (e.g., south to north, east to west, final destination station, etc.); (3) speed information (e.g., current speed, average speed, etc.); (4) next stop/station name or co-ordinates; (5) a list of upcoming stop station names or co-ordinates (possibly including the duration of the stoppage time at each station); (6) time (delta or exact clock time) for the arrival at the next stop/station (or a detailed time table with stops and arrival/departure times); and (7) expected time before mobility stops (in case current state is mobile) or resumes (in case current state is static). Further values may provide additional indications.

In an embodiment, a WTRU may be configured to refrain from performing any neighbor cell measurements while being served by a cell belonging to a mobile IAB node (e.g., as determined by the WTRU using any of the embodiments described above for indicating mobility support or current mobility state).

In an embodiment, a WTRU may be configured to refrain from performing any neighbor cell measurements while being served by a cell that is currently on the move and/or on how fast it is moving (e.g., as determined by the WTRU using any of the embodiments described above for indicating mobility state).

In an embodiment, the mobile cell may broadcast information regarding whether WTRUs or other IAB nodes connected to it should perform neighbor cell measurements. For example, a value of “1” or no broadcast of an indication may indicate that the neighbor cells should be measure, while a value of “0” may indicate that the neighbor cell measurements should not be performed.

In an embodiment, a WTRU may be configured to refrain from performing any neighbor cell measurements from the time it is handed over to a mobile cell.

In an embodiment, a WTRU may be configured to perform neighbor cell measurements for a certain time duration after being handed over to a mobile cell, and stop the measurements afterwards if it is still connected to the same mobile cell. The time duration may be configurable.

In an embodiment, a WTRU may be configured to perform neighbor cell measurements only after a certain time duration after being handed over to a mobile cell. The time duration may be configurable.

A combination of the above embodiments may also be possible. For example, a WTRU may be configured with a first time (T1) and second time (T2). Each time may correspond to the times for stopping and starting neighbor cell measurements. The WTRU may perform neighbor measurements for T1 seconds after being handed over to the mobile IAB cell, may stop performing the measurements for T2 seconds, and may start performing the measurements afterwards. The two thresholds may be absolute duration values, or they may be specified from the time of the completion of the handover.

For example, if T1 is 5 sec and T2 is 30 sec, in the first case, the WTRU may interpret this to mean that after the handover to the mobile IAB cell, the WTRU should continue performing measurements for 5 seconds, and after that has elapsed, if it is still connected to the same cell, stop performing the measurements for 30 seconds, and resume the measurements after that (i.e., 35 seconds from the handover). In the latter case, the WTRU may stop performing the measurements 30 seconds from the handover (i.e., WTRU will not be performing the measurements for 25 seconds only).

In an embodiment, a WTRU may be configured with absolute time values (e.g., at 14:35:30) when to stop and/or start the measurements, instead of time duration value(s) from being handed over to a mobile IAB node.

In an embodiment, a WTRU may be configured to apply similar behavior as above on starting/stopping neighbor cell measurements, depending on the mobility state change of the current serving cell that it is connected to. For example, the WTRU may start performing neighbor cell measurements when the mobility state of the serving cell changes from moving to static and/or high speed to low speed. In another example, the WTRU may stop performing neighbor cell measurements when the mobility state of the serving cell changes from static to moving and/or low speed to high speed.

The time duration based control of the stopping and/or starting of neighbor measurements after a handover to a mobile IAB cell that are described in the above embodiments may also be applied to a situation where the mobility state of a WTRU changes while being connected to a mobile cell. For example, a WTRU may be configured to continue performing neighbor measurements for T1 seconds after the mobility state of the serving cell changes from static to moving, stop performing the measurements for T2 seconds, resume the measurements afterwards.

In an embodiment, a WTRU may be configured to start performing neighbor cell measurements (if it was connected to a mobile cell at the moment and not performing the measurements), upon detecting a radio link failure or a handover failure, or upon being handed over to a non-mobile (fixed) cell.

In an embodiment, a WTRU may be provided with a timetable indicating when to start/stop performing neighbor cell measurements while being connected to a mobile cell. For example, the timetable may be received in a dedicated configuration from the network, read the stop/start schedule of the mobile cell from system information broadcast of the cell, and/or provided from a higher level or third party application, such as a bus/train trip planner.

In an embodiment, a WTRU may be configured to start or stop performing neighbor cell measurements while being connected to mobile cell depending on its current location. For example the WTRU may be provided with the coordinates or range of coordinates on where to start/stop neighbor cell measurements. In another example, the WTRU may get information about the location of the stops on the path of the vehicle (e.g., in a dedicated configuration, system information broadcast of the mobile cell, third party trip planner application, etc.) and may refrain from measuring neighbor cells depending on that (e.g., at the locations where the vehicle is on the move, until a certain number of meters before arriving at the next station, a certain number of meters after leaving the current station, a certain duration before the next station where the duration is calculated/estimated based on the current WTRU/vehicle speed, etc.). In another example, the WTRU may be configured with zones or areas defined in terms of coordinates, where a zone number may be determined by the modulo operation of the WTRUs coordinates with one or more parameters configured by the network, and may be configured to perform neighbor cell measurements only in a subset of such zones.

In an embodiment, a WTRU may be configured to start/stop neighbor cell measurements based on the amount of change in the WTRUs serving cell measurements. For example, the WTRU may be configured with a first threshold change in Reference Signals Received Power (RSRP) of serving cell. If the measurement of the serving cell changes (increases or decreases) by an amount that is larger than the threshold, the WTRU may start neighbor cell measurements. The WTRU may further be configured to stop neighbor cell measurements based on the amount of change in the WTRUs serving cell measurements, and a period of time. For example, if the change in serving cell measurements at the WTRU is below a threshold for at least a configured time T, the WTRU may stop neighbor cell measurements. The change in serving cell measurements may be determined as the difference between two subsequent RSRP measurements, or between RSRP measurements separated by a configured time period.

In an embodiment, a WTRU may be configured to use different S-measure values while being connected to a mobile cell. In one embodiment, a WTRU may be configured with S-measure thresholds that are specifically used while the WTRU is connected to a cell belonging to a mobile IAB node. For example, the WTRU may be configured with S-measure threshold1 to be used while the WTRU is connected to static cells (as in legacy LTE/NR) and another S-measure threshold2 to be used while the WTRU is connected to mobile cells.

In an embodiment, a WTRU may be configured with a S-measure scaling factor that is used to scale the S-measure value up/down when the WTRU connects to a mobile cell.

In an embodiment, a WTRU may be configured with a list of S-measure thresholds (or scaling factors) that are specific to certain or group of mobile cells. For example an S-measure value or scaling factor may be associated with a given mobile cell (e.g., based on PCI or CGI). In another example, an S-measure value or threshold may be associated with a set of mobile cells (e.g. cells belonging to the same gNB, as could be determined from the CGI, cells operating in a given or range of frequencies, cells that are moving at high speed, etc.)

In an embodiment, the S-measure threshold that is used while being connected to a mobile cell may be the same as the one used for static cells, but an offset or scaling value may be used that will modify the L3 filtering parameters/coefficients/times for the S-measure related measurements and evaluation. The same offset or scaling values may be used for all mobile IAB cells, or it may be specific for a given or set of IAB nodes (e.g., explicit list of cells, depending on frequency of operation, depending on speed, etc.).

In an embodiment, the S-measure threshold or scaling factor that is used while being connected to a mobile cell may be applicable only for a certain configurable duration after the WTRU is handed over to the mobile cell (e.g., provided in the RRC reconfiguration message that contains the handover command). After that duration has elapsed, the WTRU may start using the S-measure value that is used for static cells (or stops applying the scaling factor in case that was the mechanism employed).

In an embodiment, the S-measure threshold or scaling factor that is used while being connected to a mobile cell may be applicable only for a certain configurable duration after the mobility state of the serving cell is changed (e.g., mobility state changes from static to moving). After that duration has elapsed, the WTRU may start using the S-measure value that is used for static cells (or stops applying the scaling factor in case that was the mechanism employed).

In an embodiment, the S-measure threshold or scaling factor that is used while being connected to a mobile cell may be dependent on the WTRU's current location. For example, the WTRU may be provided with the coordinates or range of coordinate where to start/stop using the S-measure threshold or scaling factor for mobile cells. In another example, the WTRU may get information about the location of the stops on the path of the vehicle (e.g., in a dedicated configuration, system information broadcast of the mobile cell, third party trip planner application, etc.) and may use the mobile cell related S-measure threshold or scaling factor depending on that (e.g., at the locations where the vehicle is on the move, until a certain number of meters before the next station, a certain number of meters after leaving the current station, a certain duration before the next station where the duration is calculated/estimated based on the current WTRU/vehicle speed, etc.).

In an embodiment, the WRTU may be configured to perform relaxed neighbor measurements while connected to a mobile cell. The above described embodiments for starting/stopping neighbor cells measurements may be applied to an embodiment where the WTRU, instead of stopping neighbor cell measurements, will perform the measurements in a relaxed manner. For example, for certain durations/locations or based on a broadcasted indication from the current serving cell, the WTRU may apply a longer measurement periods, reduce the number of measurement samples to be taken, instead of stopping the measurements altogether.

In an embodiment, a gradual measurement stoppage may be performed. In a gradual measurement stoppage, a WTRU may first perform the measurement relaxation and then stops the measurements. For example, the WTRU may be configured, after being handed over to a mobile IAB cell, to perform normal neighbor cell measurements for a time duration T1, perform relaxed neighbor cell measurements for time duration T2, stop neighbor cell measurements for time duration T3, start performing relaxed neighbor cell measurements for time duration T4, start performing normal neighbor cell measurements after that, etc.

In an embodiment, the mobile cell may broadcast information regarding whether WTRUs or other IAB nodes connected to it should perform relaxed neighbor cell measurements (e.g. value of 1 or no broadcast of an indication indicating that neighbor cells should be measured in a normal way, value of 0 indicating that neighbor cell measurements should be performed in a relaxed manner).

In an embodiment, an extra S-measure like threshold may be specified in addition to the S-measure for the mobile cell. While the serving cell's signal is above this threshold, the WTRU may perform neighbor cell measurements in a relaxed manner. When the serving cell's signal falls below the threshold, the WTRU may start performing the neighbor cell measurements normally.

It should be noted that all the above embodiments for starting/stopping measurements (location based, absolute time based, WTRU mobility state change based, etc.) may be replaced or extended with measurement-relaxation-based embodiment.

In one embodiment, all the above embodiments for starting/stopping/relaxing neighbor cells measurements are applied to measurements related to the current serving cell(s). For example, the WTRU may be configured to perform relaxed serving cell measurements based on one or more of the following: (1) information broadcasted by the serving cell (e.g. value of 1 or no broadcast of an indication indicating that serving cell measurements are to be performed normally, value of 0 indicating that serving cell measurements are to be performed in a relaxed manner); (2) time information (durations to start and stop the relaxed measurements after a HO or mobility state change of the cell, absolute times to start/stop the relaxed measurements, etc.); (3) current location information; and (4) serving cell signal threshold (e.g. if the current serving cell signal strength/quality falls below a certain threshold for a given time, revert to normal serving cell measurements, if it is above a certain threshold for a given time, start performing relaxed serving cell measurements, etc.).

In one embodiment, instead of serving cell measurements relaxation, the WTRU may be configured to refrain from performing measurements even on the serving cell based on any of time, location, mobility state information, etc. It should be noted that the serving cell measurements that are referred to here is only related to RRM measurements that are used for mobility, and thus L1 measurements for radio link monitoring and scheduling are not affected.

All the above embodiments for starting/stopping/relaxing neighbor cells or serving cell measurements may be applied to an embodiment where the WTRU keeps performing the measurements normally, but will not send measurement reports. For example, for certain durations/locations or based on a broadcasted indication from the current serving cell, the WTRU may refrain from sending measurement reports.

In one embodiments, the configuration to not send measurement reports is applied to any measurement report regardless of the way the measurement report was triggered (e.g., periodic measurement reports, event triggered measurement reports that are based on absolute or relative thresholds).

In one embodiment, the configuration to not send measurement reports may be specific to the way the measurement report is triggered (e.g., periodic measurement reports not sent while even triggered measurement reported sent, or vice versa, event triggered measurement reports that are based on absolute thresholds sent while those based on relative thresholds are not sent, or vice versa, etc.).

A WTRU may be configured to perform and evaluate measurements on neighbor cells while connected to a mobile cell in a different way as compared to while being connected to other cells (e.g., static cells).

In an embodiment, the WTRU that is configured to adjust time-to-trigger (TTT) values that are used to determine whether the conditions for a measurement reporting configuration (e.g., A3 event) or conditional handover (CHO) configuration (e.g., conditional A3 event to trigger a CHO) while being connected to cells that belong to a mobile IAB (or/and they are currently mobile). For example, the WTRU may be configured with a TTT scaling factor greater than 1 that is to be applied to while being connected to a mobile cell. This way, the WTRU will report the measurement concerning the neighbor cell (or perform a CHO towards it) only when the radio conditions have been fulfilled for a considerable time, thereby preventing unnecessary ping-pong handover (e.g., WTRUs within a train/bus being temporarily handed over to a cell that does not belong to the IAB node mounted on the train/bus at a train/bus station).

In an embodiment, a WTRU may be configured to adjust the values for the offsets, hysteresis or thresholds values to be used to determine whether the conditions for a measurement reporting configuration (e.g., A3 event) or CHO configuration (e.g., conditional A3 event to trigger a CHO) while being connected to cells that belong to a mobile IAB (or/and they are currently mobile). For example, the WTRU may be configured with a hysteresis scaling factor that is to be applied to while being connected to a mobile cell. This way, the WTRU will report the measurement concerning the neighbor cell (or perform a CHO towards it) only when the radio conditions towards the neighbor cell are considerably better than the current mobile serving cell, thereby preventing unnecessary ping-pong handover (e.g. WTRUs within a train/bus being temporarily handed over to a cell that does not belong to the IAB node mounted on the train/bus at a train/bus station). Different scaling factors may be configured/applied for the hysteresis, offsets and thresholds.

In one embodiment, instead of scaling factors for the TTT or offset/hysteresis/thresholds, delta values to be added/subtracted could be specified.

In an embodiment, a WTRU may apply the same scaling factors or delta values while being connected to any mobile cell.

In an embodiment, the scaling factors or delta values applied by the WTRU are specific for the cells of a particular mobile IAB node.

In an embodiment, the scaling factors or delta values may be specific to the cells that belong to a certain group of mobile cells that fulfill a given criteria. For example, one scaling factor may be applied while being served by the cells of IAB nodes that are moving at low speed as compared to the cells of IAB nodes that are moving at high speeds.

In an embodiment, similar to the embodiments described above for starting/stopping/relaxing of the neighbor cell measurements or reporting of the measurements, the adjustment of the scaling factors or delta values to be applied (for the TTT, offset, thresholds, etc.) may depend on several factors such as the current time, the current location of the WTRU, the WTRUs trajectory (e.g., speed, direction, etc.) as compared to the serving mobile cell. an one embodiment, the scaling factors or delta values may be the same for all WTRUs in the cell/network (e.g., broadcasted in system information)

In an embodiment, the scaling factors or delta values may be specific for a given WTRU (e.g., provided via dedicated signaling).

In an embodiment, a WTRU may configured to refrain from performing measurements of mobile neighbor cells (e.g., as determined by the WTRU using any of the embodiments described above for indicating mobility support or current mobility state).

In an embodiment, a WTRU is configured to refrain from performing measurements on a mobile neighbor cell that is currently on the move (or/and on how fast it is moving) (e.g., as determined by the WTRU using any of the embodiments described above for indicating mobility state).

In an embodiment, the behavior of a WTRU to refrain from performing measurements on a mobile cell or/and it is currently on the move may depends on the current mobility state of the WTRU or/and the mobile cell. For example, a WTRU may be configured to avoid measuring mobile neighbor cells while the WTRU is stationary. In another example, a WTRU may be configured to avoid measuring mobile neighbor cells that are not moving in the same direction as the WTRU. In another example, a WTRU may be configured to avoid measuring mobile neighbor cells that are moving at a speed that is above or below a certain threshold as compared to the speed of the WTRU. In another example, a WTRU may be configured with timing information regarding when it should or should not measure mobile neighbor cells (e.g., a time table that specifies at which time duration the WTRU should or should not measure mobile neighbor cells). In another example, a WTRU may be configured with location information regarding where it should or should not measure mobile neighbor cells (e.g. a location table that specifies at which locations the WTRU should or should not measure mobile neighbor cells). In another example, a WTRU may be configured with a serving cell signal strength/quality threshold, and when the signal strength of the serving cell is above that threshold, the WTRU refrains from measuring mobile neighbor cells. In another example, an IAB node may be configured to avoid measuring mobile neighbor cells. In another example, an IAB node may be configured to avoid measuring mobile neighbor cells if itself is mobile (e.g., when two trains with mounted IAB nodes pass each other).

In an embodiment, the WTRU is configured to start performing mobile neighbor cell measurements (if it was not performing the measurements), upon detecting a radio link failure or a handover failure.

In an embodiment, the WTRU is configured via dedicated signaling regarding the behavior to measure or not measure mobile neighbor cells.

In an embodiment, the WTRU is configured with broadcast signaling from the current serving cell regarding the behavior to measure or not measure mobile neighbor cells.

All the above embodiments for starting/stopping mobile neighbor cell measurements may be applied to an embodiment where the WTRU, instead of stopping mobile neighbor cell measurements, will perform the measurements in a relaxed manner. For example, for certain durations/locations or based on a broadcasted indication from the current serving cell, the WTRU may apply a longer measurement period and/or reduce the number of measurement samples to be taken, instead of stopping the measurements altogether.

The above embodiments for starting/stopping measurements of mobile neighbor cells (location based, absolute time based, WTRU mobility state change based, etc.) may be replaced or extended with measurement-relaxation-based embodiment.

The above embodiments for starting/stopping/relaxing mobile neighbor cells may be applied to an embodiment where the WTRU continues to perform the measurements normally, but will not send measurement reports. For example, for certain durations/locations or based on a broadcasted indication from the current serving cell, the WTRU may refrain from sending measurement reports that are triggered due to mobile neighbor cells.

In an embodiment, the configuration to stop sending mobile neighbor cell related measurement reports is applied regardless of the way the measurement report was triggered (e.g. periodic measurement reports that are related to mobile neighbor cells, event triggered measurement reports that are based on absolute or relative thresholds concerning a mobile neighbor cell).

In an embodiment, the configuration to stop sending mobile neighbor cell related measurement reports may be specific to the way the measurement report is triggered (e.g. periodic measurement reports not sent while even triggered measurement reported sent, or vice versa, event triggered measurement reports that are related to mobile cells and are based on absolute thresholds (e.g., A4) sent while those based on relative thresholds (e.g., A3/A5/A6), are not sent, or vice versa, etc.).

A WTRU may be configured to perform and evaluate measurements concerning mobile neighbor cells in a different way as compared to other (static) neighbor cells.

In an embodiment, the WTRU is configured to adjust TTT values to be used to determine whether the conditions for a measurement reporting configuration (e.g. A3 event) or CHO configuration (e.g., conditional A3 event to trigger a CHO) for cells that belong to a mobile neighbor cell (or/and they are currently mobile). For example, the WTRU may be configured with a TTT scaling factor greater than 1 that is to be applied to all mobile neighbor cells. This way, the WTRU will report the measurement concerning the mobile neighbor cell (or perform a CHO towards it) only when the radio conditions have been fulfilled for a considerable time, thereby preventing unnecessary ping-pong handover (e.g. bystander WTRUs connecting to an IAB node mounted at a train/bus at a train/bus station)

In an embodiment, the WTRU is configured to adjust the values for the offsets, hysteresis or thresholds values to be used to determine whether the conditions for a measurement reporting configuration (e.g., A3 event) or CHO configuration (e.g., conditional A3 event to trigger a CHO) for mobile neighbor cells (or/and they are currently mobile). For example, the WTRU may be configured with a hysteresis scaling factor that is to be applied to all mobile neighbor cells. This way, the WTRU will report the measurement concerning the mobile neighbor cell (or perform a CHO towards it) only when the radio conditions towards that neighbor are considerably better than static cells. Different scaling factors may be configured/applied for the hysteresis, offsets and thresholds.

In an embodiment, instead of scaling factors for the TTT or offset/hysteresis/thresholds, delta values to be added/subtracted may be specified.

In an embodiment, the WTRU applies the same scaling factors or delta values to all mobile neighbor cell measurements.

In an embodiment, the scaling factors or delta values to be applied are specific for the cells of a particular mobile cell.

In an embodiment, the scaling factors or delta values may be specific for the cells belonging to a certain group of mobile cells that fulfill a given criteria. For example, one scaling factor is applied for the cells that are moving at low speed as compared to the cells that are moving at high speeds.

In an embodiment, similar to the embodiments described above for starting/stopping/relaxing of the mobile neighbor cell measurements or reporting of the measurements, the adjustment of the scaling factors or delta values to be applied (for the TTT, offset, thresholds, etc.) may depend on several factors such as the current time, the current location of the WTRU, the WTRUs trajectory (e.g., speed, direction, etc.) as compared to the mobile neighbor cell.

In an embodiment, the scaling factors or delta values may be the same for all WTRUs in the cell/network (e.g., broadcasted in system information).

In an embodiment, the scaling factors or delta values may be specific for a given WTRU (e.g., provided via dedicated signaling).

In an embodiment, the above embodiments regarding neighbor and serving cell measurements while connected to a mobile cell or mobile neighbor cell measurements (e.g., not measuring, measurement relaxation, using different parameters compared to the ones used while being connected to a non-mobile cell, using different parameters compared to the ones used while measuring non-mobile neighbor cells, etc.) may be applicable to all neighbor cells the WTRU may detect/measure.

In an embodiment, the above embodiments may be specific to a certain neighbor cell or group of neighbor cells. For example, a WTRU may be configured with an explicit list of neighbor cells that it should apply the modified measurement behavior while being connected to a mobile cell (e.g., based on a list of PCI or CGI). In another example, a WTRU may be configured to apply the modified measurement behavior to a set of neighbor cells based on a criterion (e.g., cells belonging to the same gNB, as could be determined from the CGI, cells operating in a given or range of frequencies, inter-RAT cells, mobile neighbor cells, etc.).

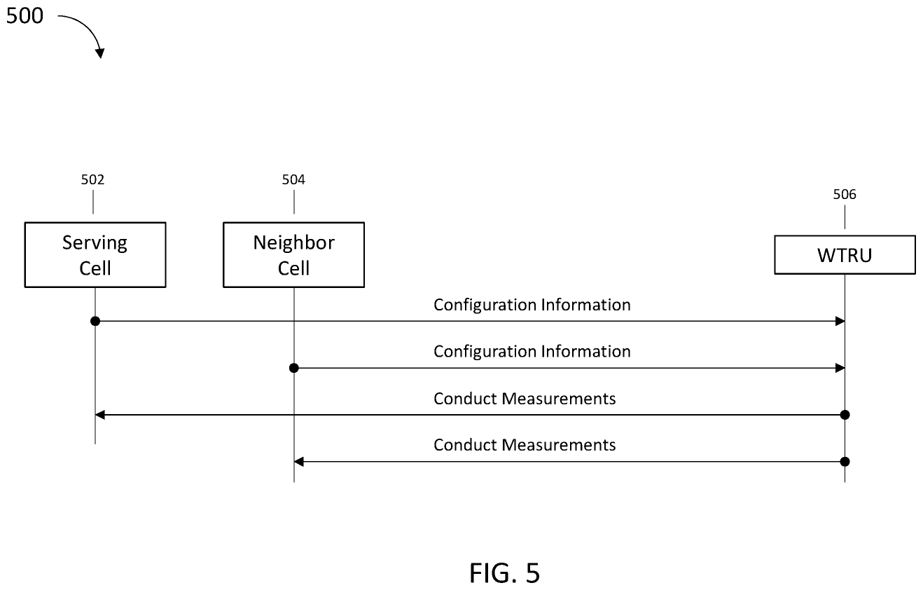

FIG. 5 is a flowchart illustrating an example procedure performed between a serving cell, neighbor cell, and WTRU. As shown in FIG. 5, the serving cell 502 and neighbor cell 504 may transmit configuration information, including measurement behavior information. The configuration information may be dependent on a mobility state of the neighbor cell and the serving cell. Based on the received configuration information, the WTRU may conduct measurements in accordance with the neighbor cell and serving cell measurement behavior information. The WTRU may conduct the measurements in accordance with the neighbor cell and serving cell measurement behavior that corresponds with the mobility state of the neighbor cell and serving cell. The measurements may include at least one of: (1) starting or stopping performing neighbor cell measurements or serving cell measurements; (2) starting or stopping sending neighbor cell measurement reports or serving neighbor cell measurement reports; (3) performing the measurements in a relaxed manner; and (4) applying different parameters for measurement evaluation.

A relaxed measurement may include (1) applying loner measurement periods and/or (2) reducing the number of measurements samples taken. The relaxed measurement may occur in a gradual manner. Further, the application of different parameters for measurement values may include (1) different time-to-trigger (TTT) values and/or (2) different hysteresis values.

The starting or stopping of performing neighbor cell measurements may be based on a location of the WTRU. The starting of performing neighbor cell measurements may occur after the mobility state of the serving cell changes from moving to static. The stopping of performing neighbor cell measurements may occur after the mobility state of the serving cell changes from static to moving. The starting of performing neighbor cell measurements may occur after the mobility state of the neighbor cell changes from moving to static. The stopping of performing neighbor cell measurements may occur after the mobility state of the neighbor cell changes from static to moving.

The above embodiments described proposed behaviors of WTRUs in CONNECTED mode, mainly focusing on measurements of neighbor cells and the serving cell while connected to a mobile cell or measurements of mobile neighbor cells (e.g., not measuring, measurement relaxation, using different parameters compared to the ones used while being connected to a non-mobile cell, using different parameters compared to the ones used while measuring non-mobile neighbor cells, etc.).

All of the embodiments are equally applicable to WTRUs in IDLE mode that are simply camping on a mobile cell. For example, the WTRU may modify the behavior of performing neighbor measurements while camping on a mobile cell or modify the behavior of performing measurements on neighbor cells that are mobile, where the modification of behavior could be to start/stop performing the measurements or performing the measurements in a relaxed manner for a configurable time duration, depending on location, depending on the serving cell's signal strength/quality or relative signal strength/quality change, etc.

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

1. A method performed by a wireless transmit/receive unit (WTRU), the method comprising:
receiving, from an IAB node, a first system information block (SIB), the first SIB indicating whether the IAB node supports mobility;
receiving first configuration information, wherein the first configuration information includes a list of neighboring mobile IAB nodes;
receiving second configuration information for performing measurements on a neighbor IAB node, selected from the list of neighboring mobile IAB nodes, and serving IAB node, wherein the configuration information is dependent on a mobility state of the neighbor IAB node and the mobility state of the serving IAB node; and
conducting measurements of the neighbor cell and serving cell in accordance with the second configuration information.

2. The method of claim 19, wherein performing the measurements in a relaxed manner includes at least one of the following:
applying longer measurements periods; and
reducing a number of measurement samples taken.

3. The method of claim 19, wherein applying different parameters for measurement values includes applying at least one of the following:
different time-to-trigger (TTT) values; and
different hysteresis values.

4. The method of claim 19, wherein the starting of performing neighbor cell measurements occurs after the mobility state of the serving cell changes from moving to static.

5. The method of claim 19, wherein the stopping of performing neighbor cell measurements occurs after the mobility state of the serving cell changes from static to moving.

6. The method of claim 19, wherein the starting of performing neighbor cell measurements occurs after the mobility state of the neighbor cell changes from moving to static.

7. The method of claim 19, wherein the stopping of performing neighbor cell measurements occurs after the mobility state of the neighbor cell changes from static to moving.

8. The method of claim 19, wherein the starting or stopping of performing neighbor cell measurements is based on a location of the WTRU.

9. The method of claim 19, wherein the measurements in the relaxed manner occurs in a gradual manner.

10. A wireless transmit/receive unit (WTRU) comprising:
a transmitter, a receiver, and a processor,
the receiver configured to receive, from a first system information block (SIB), the first SIB indicating whether the IAB node supports mobility;
the receiver configured to receive first configuration information, wherein the first configuration information includes a list of neighboring mobile IAB nodes;
the receiver configured to receive second configuration information for performing measurements on a neighbor IAB node, selected from the list of neighboring IAB nodes, and serving IAB node, wherein the configuration information is dependent on a mobility state of the neighbor IAB node and the mobility state of the serving IAB node; and
the processor configured to conduct measurements of the neighbor cell and serving cell in accordance with the second configuration information.

11. The WTRU of claim 20, wherein performing the measurements in a relaxed manner includes at least one of the following:
applying longer measurements periods; and
reducing a number of measurement samples taken.

12. The WTRU of claim 20, wherein applying different parameters for measurement values includes applying at least one of the following:
different time-to-trigger (TTT) values; and
different hysteresis values.

13. The WTRU of claim 20, wherein the starting of performing neighbor cell measurements occurs after the mobility state of the serving cell changes from moving to static.

14. The WTRU of claim 20, wherein the stopping of performing neighbor cell measurements occurs after the mobility state of the serving cell changes from static to moving.

15. The WTRU of claim 20, wherein the starting of performing neighbor cell measurements occurs after the mobility state of the neighbor cell changes from moving to static.

16. The WTRU of claim 20, wherein the stopping of performing neighbor cell measurements occurs after the mobility state of the neighbor cell changes from static to moving.

17. The WTRU of claim 20, wherein the starting or stopping of performing neighbor cell measurements is based on a location of the WTRU.

18. The WTRU of claim 20, wherein the measurements in the relaxed manner occurs in a gradual manner.

19. The method of claim 1, wherein conducting measurements in accordance with the second configuration information that depends on the mobility state of the neighbor cell and the mobility state of the serving cell includes at least one of the following:
starting or stopping performing neighbor cell measurements or serving cell measurements;
starting or stopping sending neighbor cell measurement reports or serving neighbor cell measurement reports;
performing the measurements in a relaxed manner; or
applying different parameters for measurement evaluation.

20. The WTRU of claim 10, wherein conducting measurements in accordance with the second configuration information that depends on the mobility state of the neighbor cell and the mobility state of the serving cell includes at least one of the following:
starting or stopping performing neighbor cell measurements or serving cell measurements;
starting or stopping sending neighbor cell measurement reports or serving neighbor cell measurement reports;
performing the measurements in a relaxed manner; or
applying different parameters for measurement evaluation.
